(19) United States
(12) Patent Application Publication
(10) Pub. No.: US 2026/0162645 A1
(43) Pub. Date: Jun. 11, 2026

(54) ACTIVE NOISE REDUCTION METHOD AND HEARING AID DEVICE

(71) Applicant: Anker Innovations Technology Co., Ltd., Changsha (CN)

(72) Inventors: Jiasheng Li, Shenzhen (CN); Yong Wang, Shenzhen (CN)

(21) Appl. No.: 19/179,595

(22) Filed: Apr. 15, 2025

(30) Foreign Application Priority Data
Apr. 24, 2024 (CN) 202410501141.5

(51) Int. Cl. G10K 11/178; H04R 25/00

(52) U.S. Cl. CPC G10K 11/17873; G10K 11/17853; H04R 25/50; H04R 25/70; H04R 2460/01

(57) ABSTRACT

The present application relates to an active noise reduction method and a hearing aid device. The method comprises: obtaining, in an active noise reduction mode, current frequency response information and original target frequency response information of a feedforward filter; determining a current noise reduction depth of the hearing aid device; if the current noise reduction depth does not reach a target noise reduction depth, updating an active noise reduction parameter of the hearing aid device, re-determining the current frequency response information, and returning to the step of determining a current noise reduction depth, so that the active noise reduction parameter of the hearing aid device is iteratively adjusted until the current noise reduction depth reaches the target noise reduction depth, and if the current noise reduction depth reaches the target noise reduction depth, performing active noise reduction in the hearing aid device.

### CROSS-REFERENCE TO RELATED APPLICATION

The present disclosure claims priority to Chinese Patent Application No. 202410501141.5, filed on Apr. 24, 2024, the entire disclosures of which are incorporated herein by reference.

### TECHNICAL FIELD

The present application relates to the field of sound processing technology, in particular to an active noise reduction method and a hearing aid device.

### BACKGROUND

With the development of sound processing technology, active noise reduction technology has emerged enabling hearing aid devices to actively reduce external noise perceived by an object (e.g., a user). In conventional technologies, active noise reduction usually involves directly analyzing the frequency and phase of the external noise and generating an equal-amplitude inverted signal to fully counteract the external noise as much as possible, thereby reducing the noise actually heard by the human ear and providing a quieter user experience.

However, when attempting to fully cancel the external noise by generating the equal-amplitude inverted signal, the noise reduction capability of hearing aid devices is limited, which can easily result in residue noise and affect the effectiveness of active noise reduction.

### SUMMARY

In view of the above technical problems, it is necessary to provide an active noise reduction method and apparatus, a hearing aid device, and a computer-readable storage medium, which can improve the active noise reduction effect.

In a first aspect, the present application provides an active noise reduction method applied to a hearing aid device. The method includes: obtaining, in an active noise reduction mode, current frequency response information and original target frequency response information of a feedforward filter; determining a current noise reduction depth of the hearing aid device according to the current frequency response information and the original target frequency response information; if the current noise reduction depth does not reach a target noise reduction depth, iteratively adjusting an active noise reduction parameter of the hearing aid device until the current noise reduction depth reaches the target noise reduction depth, by: updating an active noise reduction parameter of the hearing aid device, re-determining the current frequency response information of the feedforward filter according to the updated active noise reduction parameter, and returning to the step of determining a current noise reduction depth of the hearing aid device according to the current frequency response information and the original target frequency response information. For example, based on the re-determined current frequency response information and the original target frequency response information, the current noise reduction depth of the hearing aid device may be updated. The target noise reduction depth is determined based on hearing loss information of a target object. Alternatively, if the current noise reduction depth reaches the target noise reduction depth, active noise reduction is performed in the hearing aid device according to the active noise reduction parameter of the hearing aid device.

In a second aspect, the present application further provides an active noise reduction apparatus applied to a hearing aid device. The apparatus includes: an obtaining module, configured to obtain, in an active noise reduction mode, current frequency response information and original target frequency response information of a feedforward filter; a determination module, configured to determine a current noise reduction depth of the hearing aid device according to the current frequency response information and the original target frequency response information; an update module, configured to, if the current noise reduction depth does not reach a target noise reduction depth, iteratively adjust an active noise reduction parameter of the hearing aid device until the current noise reduction depth reaches the target noise reduction depth, such as: update an active noise reduction parameter of the hearing aid device, re-determine the current frequency response information of the feedforward filter according to the updated active noise reduction parameter, and return to the step of determining a current noise reduction depth of the hearing aid device according to the current frequency response information and the original target frequency response information, where the target noise reduction depth is determined based on hearing loss information of a target object; and an active noise reduction module, configured to, if the current noise reduction depth reaches the target noise reduction depth, perform active noise reduction in the hearing aid device according to the active noise reduction parameter of the hearing aid device.

In a third aspect, the present application further provides a hearing aid device. The hearing aid device includes a memory and a processor, the memory storing a computer program or instructions, and the processor implementing the following steps when executing the computer program or the instructions: obtaining, in an active noise reduction mode, current frequency response information and original target frequency response information of a feedforward filter; determining a current noise reduction depth of the hearing aid device according to the current frequency response information and the original target frequency response information; if the current noise reduction depth does not reach a target noise reduction depth, iteratively adjusting an active noise reduction parameter of the hearing aid device until the current noise reduction depth reaches the target noise reduction depth, by: updating an active noise reduction parameter of the hearing aid device, re-determining the current frequency response information of the feedforward filter according to the updated active noise reduction parameter, and returning to the step of determining a current noise reduction depth of the hearing aid device according to the current frequency response information and the original target frequency response information, where the target noise reduction depth is determined based on hearing loss information of a target object; and if the current noise reduction depth reaches the target noise reduction depth, performing active noise reduction in the hearing aid device according to the active noise reduction parameter of the hearing aid device.

In a fourth aspect, the present application further provides a computer-readable storage medium. The computer-readable storage medium stores a computer program that, when executed by a processor, implements the following steps: obtaining, in an active noise reduction mode, current frequency response information and original target frequency response information of a feedforward filter; determining a current noise reduction depth of the hearing aid device according to the current frequency response information and the original target frequency response information; if the current noise reduction depth does not reach a target noise reduction depth, iteratively adjusting an active noise reduction parameter of the hearing aid device until the current noise reduction depth reaches the target noise reduction depth, by: updating an active noise reduction parameter of the hearing aid device, re-determining the current frequency response information of the feedforward filter according to the updated active noise reduction parameter, and returning to the step of determining a current noise reduction depth of the hearing aid device according to the current frequency response information and the original target frequency response information, where the target noise reduction depth is determined based on hearing loss information of a target object; and if the current noise reduction depth reaches the target noise reduction depth, performing active noise reduction in the hearing aid device according to the active noise reduction parameter of the hearing aid device.

In a fifth aspect, the present application further provides a computer program product. The computer program product includes a computer program that, when executed by a processor, implements the following steps: obtaining, in an active noise reduction mode, current frequency response information and original target frequency response information of a feedforward filter; determining a current noise reduction depth of the hearing aid device according to the current frequency response information and the original target frequency response information; if the current noise reduction depth does not reach a target noise reduction depth, iteratively adjusting an active noise reduction parameter of the hearing aid device until the current noise reduction depth reaches the target noise reduction depth, by: updating an active noise reduction parameter of the hearing aid device, re-determining the current frequency response information of the feedforward filter according to the updated active noise reduction parameter, and returning to the step of determining a current noise reduction depth of the hearing aid device according to the current frequency response information and the original target frequency response information, where the target noise reduction depth is determined based on hearing loss information of a target object; and if the current noise reduction depth reaches the target noise reduction depth, performing active noise reduction in the hearing aid device according to the active noise reduction parameter of the hearing aid device.

According to the above active noise reduction method and apparatus, hearing aid device, and storage medium, firstly, in the active noise reduction mode, the hearing aid device obtains the current frequency response information and the original target frequency response information of the feedforward filter; the current noise reduction depth of the hearing aid device is determined according to the current frequency response information and the original target frequency response information. Further, because the target noise reduction depth of the hearing aid device is determined based on the hearing loss information of the target object, if the current noise reduction depth of the hearing aid device does not reach the target noise reduction depth, an active noise reduction parameter of the hearing aid device is iteratively adjusted until the current noise reduction depth reaches the target noise reduction depth. For example, the active noise reduction parameter of the hearing aid device is updated, the current frequency response information of the feedforward filter is re-determined according to the updated active noise reduction parameter, and the step of determining the current noise reduction depth of the hearing aid device according to the current frequency response information and the original target frequency response information is returned. If the current noise reduction depth reaches the target noise reduction depth, active noise reduction is performed in the hearing aid device according to the active noise reduction parameter of the hearing aid device.

As such, this approach ensures that the ultimately used active noise reduction parameter matches the actual hearing capability of the target object, avoiding the waste of the noise reduction capability due to excessive noise reduction. Therefore, even when the noise reduction capability of the hearing aid device is limited, noise within the hearing capability of the target object can be canceled or eliminated as much as possible. In contrast, noise beyond the hearing capability of the target object does not need to be canceled. This targeted noise reduction within the hearing capability of the target object avoids wasting the noise reduction capability of the hearing aid device. Even with limited noise reduction capability, it is unlikely to result in residue noise, which can enhance the active noise reduction effect of the hearing aid device.

### BRIEF DESCRIPTION OF THE DRAWINGS

FIG. 1 is a schematic flowchart of an active noise reduction method in one example;

FIG. 2 is a schematic flowchart of obtaining original target frequency response information of a feedforward filter in one example;

FIG. 3 is a schematic flowchart of updating an active noise reduction parameter of a hearing aid device in one example;

FIG. 4 is a structural block diagram of an active noise reduction apparatus in one example; and

FIG. 5 is an internal structural diagram of a hearing aid device in one example.

### DETAILED DESCRIPTION

In order to make the objectives, technical solutions, and advantages of the present application clearer, the following further describes the present application in detail in conjunction with the accompanying drawings and examples. It is to be understood that the specific examples described herein are only used for explaining the present application, and are not used for limiting the present application.

At present, during active noise reduction, a signal that has a same amplitude as an external noise and has an opposite phase to external noise is usually generated to fully cancel the external noise as much as possible. However, on the one hand, due to different degrees of hearing loss of different users, external noise beyond a user's hearing range may be canceled, which wastes the noise reduction capability of a hearing aid device and wastes resources. On the other hand, due to the limited noise reduction capability of the hearing aid device, if external noise in all frequency bands is canceled as much as possible, inevitably resulting in residue noise, which affects the effect of active noise reduction.

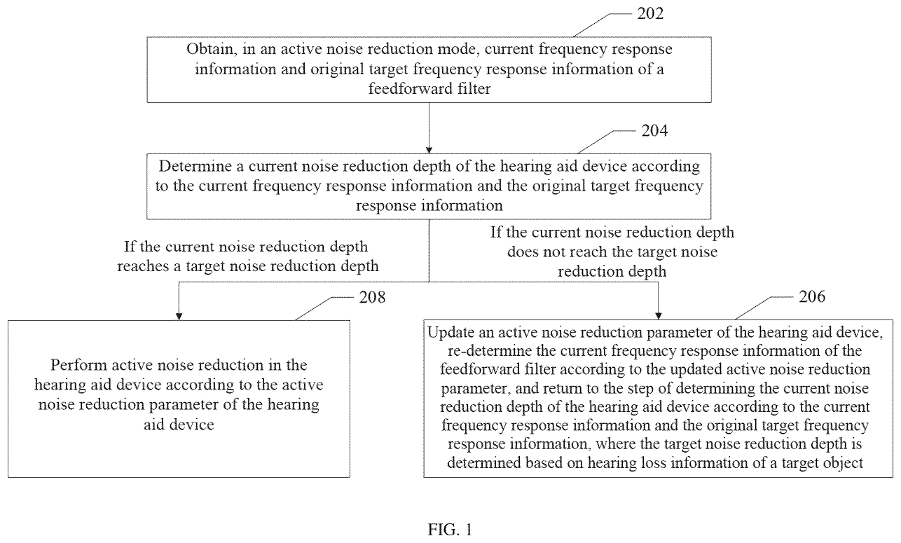

In one example, as shown in FIG. 1, an active noise reduction method is provided. The method is applied to a hearing aid device as an example for explanation, and includes the following steps:

Step 202: Obtain, in an active noise reduction mode, current frequency response information and original target frequency response information of a feedforward filter.

The hearing aid device may be a hearing aid or an earphone (e.g., with hearing aid capability and/or with Bluetooth functionality). The hearing aid device is equipped with components such as the feedforward filter, a feedforward microphone, a feedback microphone, and a speaker. The feedforward filter is used for feedforward filtering to cancel external noise. The original target frequency response information is target frequency response information of the feedforward filter without considering hearing loss information of a target object. If the target object does not have hearing loss, the feedforward filter performs active noise reduction based on the original target frequency response information, and the hearing aid device can achieve a good active noise reduction effect, where the active noise reduction effect can represent that the target object cannot hear external noise. The target object may be a user of the hearing aid device, such as a wearer of the Bluetooth headphone with hearing aid capability, and the hearing loss information may be a hearing loss curve of the target object.

As an example, step 202 includes: obtaining, in the active noise reduction mode, the current frequency response information of the hearing aid device; and detecting, according to coherence between a first sound signal captured by the feedforward microphone and a second sound signal captured by the feedback microphone, the original target frequency response information of the feedforward filter of the hearing aid device.

Because the original target frequency response information is affected by the wearing state of the hearing aid device, each time the hearing aid device enters the active noise reduction mode, re-detection of the original target frequency response information of the feedforward filter is triggered to ensure the accuracy of the original target frequency response information.

As an example, the frequency response information may be response information of the feedforward filter at each preset frequency point, and the response information includes an amplitude and a phase of an audio signal output by the feedforward filter.

Step 204: Determine a current noise reduction depth of the hearing aid device according to the current frequency response information and the original target frequency response information.

As an example, the current frequency response information includes a current frequency response value at each preset frequency point, the original target frequency response information includes an original target frequency response value at each preset frequency point, and the current noise reduction depth includes a current noise reduction depth value at each preset frequency point; the process of calculating a current noise reduction depth of the hearing aid device according to the current frequency response information and the original target frequency response information is as follows:

$$at \hat{t} ( f ) = 10 log ( {‖ \frac{{H}_{k} - {H}_{opt}}{{H}_{opt}} ‖}^{2} )$$

where at\hat{t}(f) represents the current noise reduction depth value when the frequency is f, Hₖ represents the current frequency response value when the frequency is f, and Hₒₚₜ represents the original target frequency response value when the frequency is f.

The noise reduction depth is used for representing the noise reduction capability of the hearing aid device, measured in decibels. For example, assuming that the noise reduction depth is 30 decibels and the external noise is 40 decibels, the external noise perceived by the target object is 10 decibels.

Step 206: If the current noise reduction depth does not reach a target noise reduction depth, update an active noise reduction parameter of the hearing aid device, re-determine the current frequency response information of the feedforward filter according to the updated active noise reduction parameter, and return to the step of determining a current noise reduction depth of the hearing aid device according to the current frequency response information and the original target frequency response information, so that the active noise reduction parameter of the hearing aid device is iteratively adjusted until the current noise reduction depth reaches the target noise reduction depth. The target noise reduction depth is determined based on hearing loss information of a target object.

The active noise reduction parameter may be a filter parameter of the feedforward filter. By adjusting the filter parameter, the output of the feedforward filter can be adjusted, which means, the current frequency response information of the feedforward filter can be adjusted.

As an example, step 206 includes: if the current noise reduction depth does not reach the target noise reduction depth, updating the active noise reduction parameter of the hearing aid device according to the current frequency response information, the original target frequency response information, and the hearing loss information of the target object, and re-obtaining the current frequency response information of the feedforward filter according to the updated active noise reduction parameter; and returning to the step of determining a current noise reduction depth of the hearing aid device according to the current frequency response information and the original target frequency response information, so that the active noise reduction parameter of the hearing aid device is iteratively adjusted until the current noise reduction depth reaches the target noise reduction depth. The target noise reduction depth is obtained by adjusting an original noise reduction depth of the hearing aid device according to the hearing loss information of the target object.

The original noise reduction depth is a noise reduction depth that the hearing aid device can achieve during active noise reduction without considering the hearing loss information of the target object; the target noise reduction depth is a noise reduction depth that the hearing aid device is to achieve during active noise reduction with considering the hearing loss information of the target object.

As an example, the original noise reduction depth includes an original noise reduction depth value at each preset frequency point, measured in decibels; the hearing loss information of the target object can be a hearing loss value of the target object at each preset frequency point, and the hearing loss value can be measured in decibels. Therefore, for each preset frequency point, a target noise reduction depth value at each preset frequency point can be obtained by subtracting the hearing loss value from the original noise reduction depth value at the preset frequency point, where the target noise reduction depth value at each preset frequency point is the target noise reduction depth.

Step 208: If the current noise reduction depth reaches the target noise reduction depth, perform active noise reduction in the hearing aid device according to the active noise reduction parameter of the hearing aid device.

As an example, step 208 includes: if the current noise reduction depth reaches the target noise reduction depth, it indicates that the active noise reduction effect of the hearing aid device has reached an expected active noise reduction effect. Thus, the current active noise reduction parameter of the hearing aid device is designated as the filter parameter of the feedforward filter, and active noise reduction is performed in the hearing aid device according to the filter parameter, where the active noise reduction process can generate a cancellation signal by the feedforward filter to cancel external noise.

In the above active noise reduction method, firstly, in the active noise reduction mode, the hearing aid device obtains the current frequency response information and the original target frequency response information of the feedforward filter; the current noise reduction depth of the hearing aid device is determined according to the current frequency response information and the original target frequency response information. Further, because the target noise reduction depth of the hearing aid device is determined based on the hearing loss information of the target object, if the current noise reduction depth of the hearing aid device does not reach the target noise reduction depth, the active noise reduction parameter of the hearing aid device is updated, the current frequency response information of the feedforward filter is re-determined according to the updated active noise reduction parameter, and the step of determining the current noise reduction depth of the hearing aid device according to the current frequency response information and the original target frequency response information is returned; so that the active noise reduction parameter of the hearing aid device is iteratively adjusted until the current noise reduction depth reaches the target noise reduction depth. If the current noise reduction depth reaches the target noise reduction depth, active noise reduction is performed in the hearing aid device according to the active noise reduction parameter of the hearing aid device. On the one hand, in the case of limited noise reduction capability of the hearing aid device, noise within the hearing capability of the target object can be canceled as much as possible, while noise beyond the hearing capability of the target object does not need to be canceled. In this targeted noise reduction within the hearing capability of the target object, it is unlikely to produce residue noise when the noise reduction capability of the hearing aid device is limited, which can improve the effect of active noise reduction. On the other hand, the noise beyond the hearing capability of the target object does not need to be canceled, which can avoid wasting the noise reduction capability of the hearing aid device and reduce the waste of resources when the hearing aid device performs active noise reduction.

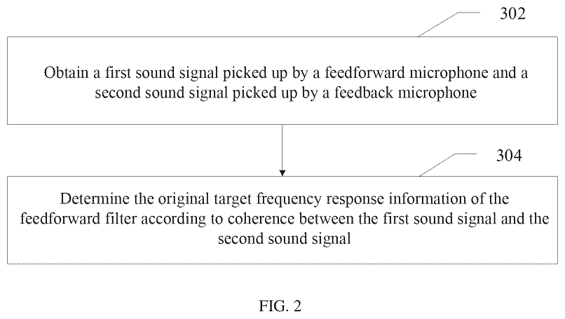

In one example, as shown in FIG. 2, obtaining original target frequency response information of a feedforward filter includes:

Step 302: Obtain a first sound signal captured by a feedforward microphone and a second sound signal captured by a feedback microphone.

Step 304: Determine the original target frequency response information of the feedforward filter according to coherence between the first sound signal and the second sound signal. The original target frequency response information includes an original target frequency response value at each preset frequency point.

As an example, step 302 to step 304 include: obtaining the first sound signal captured by the feedforward microphone and the second sound signal captured by the feedback microphone; according to a coherence value of the first sound signal and the second sound signal at each preset frequency point, identifying the preset frequency point where the first sound signal and the second sound signal are not coherent as a target frequency point, obtaining the current frequency response value of the feedforward filter at the target frequency point as a target frequency response value, and returning to the step of obtaining a first sound signal captured by a feedforward microphone and a second sound signal captured by a feedback microphone until target frequency response values at all preset frequency points are obtained.

In one example, the original target frequency response information includes a target frequency response value at each preset frequency point; determining the original target frequency response information of the feedforward filter according to coherence between the first sound signal and the second sound signal includes: calculating a coherence value between the first sound signal and the second sound signal at each preset frequency point; if the coherence value at the preset frequency point is less than or equal to a preset threshold, collecting a current frequency response value of the feedforward filter at the preset frequency point as the target frequency response value; if the coherence value at the preset frequency point is greater than the preset threshold, returning to the step of obtaining a first sound signal captured by a feedforward microphone and a second sound signal captured by a feedback microphone, until target frequency response values at all preset frequency points are collected.

Specifically, for each preset frequency point, the coherence value between the first sound signal and the second sound signal at the preset frequency point is calculated, where the coherence value is used for representing a magnitude of coherence. The larger the coherence value, the stronger the coherence, and the smaller the coherence value, the weaker the coherence. If the coherence value at the preset frequency point is less than or equal to the preset threshold, it indicates that the first sound signal and the second sound signal are not coherent at the preset frequency point, and the current frequency response value of the feedforward filter at the preset frequency point is collected as the target frequency response value. If the coherence value at the preset frequency point is greater than the preset threshold, the filter parameter of the feedforward filter at the preset frequency point is adjusted, and the step of obtaining a first sound signal captured by a feedforward microphone and a second sound signal captured by a feedback microphone is returned, until the target frequency response values at all preset frequency points are collected.

As an example, the preset threshold may be set to 0.

In this example, by continuously detecting the coherence between the first sound signal captured by the feedforward microphone and the second sound signal captured by the feedback microphone, the original target frequency response information can be accurately extracted from the frequency response information of the feedforward filter. As such, the original target frequency response information can be used to detect the noise reduction depth of the hearing aid device, which lays the foundation for the subsequent active noise reduction process.

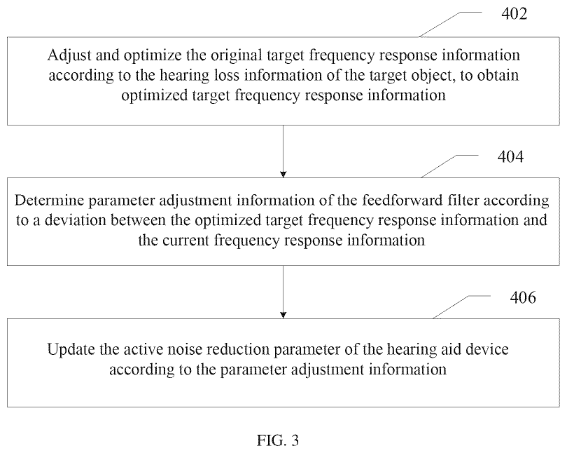

In one example, as shown in FIG. 3, updating an active noise reduction parameter of the hearing aid device includes:

Step 402: Adjust and optimize the original target frequency response information according to the hearing loss information of the target object, to obtain optimized target frequency response information.

The hearing loss information may be a hearing loss value of the target object at each preset frequency point, and the original target frequency response information may be an original target frequency response value of the feedforward filter at each preset frequency point.

As an example, step 402 includes: for each preset frequency point, calculating an optimized target frequency response value at each preset frequency point according to the original target frequency response value of the feedforward filter and the hearing loss value of the target object at the preset frequency point, and designating the optimized target frequency response value at each preset frequency point as the optimized target frequency response information.

As an example, the difference between the original target frequency response value of the feedforward filter and the hearing loss value of the target object at the preset frequency point can be calculated as the optimized target frequency response value.

Step 404: Determine parameter adjustment information of the feedforward filter according to a deviation between the optimized target frequency response information and the current frequency response information.

The parameter adjustment information may be at least one of an adjustment amplitude and an adjustment direction of the filter parameter. The filter parameter is adjusted based on the frequency response information of the feedforward filter, which means, to adjust the phase and amplitude of an output signal of the feedforward filter.

As an example, step 404 includes: detecting a deviation value between an optimized target frequency response value and the current frequency response value at each preset frequency point; and searching for the parameter adjustment amplitude and parameter adjustment direction of the feedforward filter at each preset frequency point according to the deviation value at each preset frequency point.

Step 406: Update the active noise reduction parameter of the hearing aid device according to the parameter adjustment information. The active noise reduction parameter is a filter parameter of the feedforward filter.

As an example, step 406 includes: updating the filter parameter of the feedforward filter at each preset frequency point according to the parameter adjustment amplitude and the parameter adjustment direction.

In one example, adjusting and optimizing the original target frequency response information according to the hearing loss information of the target object, to obtain optimized target frequency response information, includes: obtaining the hearing loss information of the target object, and determining target hearing loss information at the feedforward filter according to the hearing loss information and a target transfer function; and optimizing and adjusting the original target frequency response information of the feedforward filter according to the target hearing loss information, to obtain the optimized target frequency response information.

The hearing loss information may be hearing loss information of the target object at the feedback microphone; the target hearing loss information includes a target hearing loss value at each preset frequency point.

Specifically, a hearing loss value of the target object at each preset frequency point is obtained; the target hearing loss value of the target object at the feedforward filter is calculated according to the target transfer function; for each preset frequency point, the difference between the original target frequency response value and the target hearing loss value at the preset frequency point is calculated as the optimized target frequency response value at the preset frequency point; and the optimized target frequency response values at each preset frequency point is designated as the optimized target frequency response information.

As an example, the target transfer function is a transfer function corresponding to a sound transfer path from the feedforward filter to the feedback microphone.

In the above example, the original target frequency response information of the feedforward filter is first optimized by combining the hearing loss information of the target object to obtain the optimized target frequency response information, where the optimized target frequency response information better matches the actual hearing capability of the target object. Then the parameter adjustment information of the feedforward filter is determined according to the deviation between the optimized target frequency response information and the current frequency response information. The active noise reduction parameter of the hearing aid device is updated according to the parameter adjustment information, such that the updated active noise reduction parameter better matches the actual hearing capability of the target object, thereby improving the accuracy of the updated active noise reduction parameter and improving the effect of active noise reduction.

In one example, updating an active noise reduction parameter of the hearing aid device according to the parameter adjustment information includes: obtaining current coherence information between the first sound signal captured by the feedforward microphone and the second sound signal captured by the feedback microphone; determining parameter adjustment step information of the feedforward filter according to the current coherence information; and updating the active noise reduction parameter of the hearing aid device according to the parameter adjustment step information and the parameter adjustment information. The parameter adjustment step information includes a parameter adjustment step at each preset frequency point.

Specifically, the current coherence information between the first sound signal captured by the feedforward microphone and the second sound signal captured by the feedback microphone is obtained, where the current coherence information includes a current coherence value at each preset frequency point. The parameter adjustment step of the feedforward filter at each preset frequency point is determined according to the current coherence value at each preset frequency point, where the larger the current coherence value, the stronger the coherence, the larger the parameter adjustment step, and the smaller the current coherence value, the weaker the coherence, and the smaller the parameter adjustment step. For each preset frequency point, a target parameter adjustment amplitude is determined according to the parameter adjustment step and the parameter adjustment amplitude at the preset frequency point, and the filter parameter of the feedforward filter at the preset frequency point is updated according to the target parameter adjustment amplitude and the parameter adjustment direction at the preset frequency point.

As an example, determining a target parameter adjustment amplitude according to the parameter adjustment step and the parameter adjustment amplitude at the preset frequency point includes: if the parameter adjustment step is greater than the parameter adjustment amplitude, designating the parameter adjustment amplitude as a final target parameter adjustment amplitude; if the parameter adjustment step is less than or equal to the parameter adjustment amplitude, designating the parameter adjustment step as the target parameter adjustment amplitude.

In the above example, the parameter adjustment step at each preset frequency point is set according to the coherence of the first sound signal and the second sound signal at each preset frequency point. Then, the final target parameter adjustment amplitude is generated by combining the parameter adjustment step and the parameter adjustment amplitude, such that the adjustment amplitude of the filter parameter of the feedforward filter is not too large or too small each time the filter parameter is updated, and the amplitude of adjusting the filter parameter each time is more reasonable and accurate.

In one example, the active noise reduction method further includes: detecting a residual noise amplitude of the second sound signal captured by the feedback microphone at the preset frequency point; and if the residual noise amplitude at the preset frequency point is greater than a preset amplitude threshold, keeping a gain of audio played by the hearing aid device at the preset frequency point unchanged; or if the residual noise amplitude at the preset frequency point is less than or equal to the preset amplitude threshold, decreasing the gain of audio played by the hearing aid device at the preset frequency point.

The preset amplitude threshold may be determined according to the hearing capability of the target object. The target object can hardly perceive sound signals less than or equal to the preset amplitude threshold, but can perceive sound signals greater than the preset amplitude threshold.

Specifically, the residual noise amplitude of the second sound signal captured by the feedback microphone at the preset frequency point is detected. If the residual noise amplitude at the preset frequency point is greater than the preset amplitude threshold, it indicates that the residual noise of the external sound signal entering the ear canal affects the hearing experience of the target object on the audio played by the hearing aid device, so the gain of the audio played by the hearing aid device at the preset frequency point is kept unchanged, to ensure that the played audio target heard by the target object is clear enough and is not affected by the residual noise. If the residual noise amplitude at the preset frequency point is less than or equal to the preset amplitude threshold, it indicates that the residual noise of the external sound signal entering the ear canal does not affect the hearing experience of the target object on the audio played by the hearing aid device, so the gain of the audio played by the hearing aid device at the preset frequency point is decreased, to ensure that the target object can hear the audio clearly without using a large gain, thereby reducing the probability of howling or acoustic feedback.

Notably, the hearing aid device needs to amplify the played audio, the amplified played audio is not only heard by the user, but also passed from the inside of the device to the outside of the device and received by the feedforward microphone again to form closed-loop howling, and the larger the amplified gain of the played audio, the higher the probability of howling (e.g., acoustic feedback). Therefore, this example ensures that the target object can clearly hear the played audio, and decreases the gain of the played audio as much as possible to reduce the probability of howling.

In one example, before the step of obtaining, in an active noise reduction mode, current frequency response information and original target frequency response information of a feedforward filter, the active noise reduction method further includes: obtaining the hearing loss information of the target object; and adjusting an original noise reduction depth of the hearing aid device according to the hearing loss information, to obtain the target noise reduction depth of the hearing aid device.

Specifically, the hearing loss information sent by the user through a terminal device and the original noise reduction depth of the hearing aid device are obtained, where the hearing loss information includes a hearing loss value at each preset frequency point, and the original noise reduction depth includes a noise reduction depth value at each preset frequency point; the difference between the noise reduction depth value and the hearing loss value at each preset frequency point is calculated as a target noise reduction depth value respectively; and the target noise reduction depth values at the preset frequency points are jointly designated as a target noise reduction depth of the hearing aid device.

In one example, the obtaining the hearing loss information of the target object includes: receiving the hearing loss information sent by a terminal device, where the terminal device is configured to detect the hearing loss information of the target object; where the terminal device can receive the hearing loss information manually input by the target object, measure the hearing loss information of the target object on line, or photograph a hearing loss curve to obtain the hearing loss information.

In one example, the obtaining hearing loss information of the target object includes: receiving the hearing loss information sent by a cloud server, where the cloud server is configured to store the hearing loss information of the target object.

If the terminal device previously obtains the hearing loss information of the target object, the terminal device uploads the hearing loss information of the target object to the cloud server for storage, such that the hearing aid device can directly obtain the stored hearing loss information from the cloud server.

In this example, the hearing aid device can obtain the hearing loss information of the target object from the terminal device or the cloud server, and then adjust its original noise reduction depth using the hearing loss information to obtain the target noise reduction depth, such that the target noise reduction depth of the hearing aid device matches the actual hearing capability of the target object. In this approach, the active noise reduction parameter determined by the target noise reduction depth also better matches the actual hearing capability of the target object, which improves the active noise reduction effect of the hearing aid device.

In one example, in the active noise reduction mode, the first sound signal captured by the feedforward microphone and the second sound signal captured by the feedback microphone are obtained. For each preset frequency point, the coherence value between the first sound signal and the second sound signal at the preset frequency point is calculated, where the coherence value is used for representing the magnitude of coherence, the larger the coherence value, the stronger the coherence, and the smaller the coherence value, the weaker the coherence. If the coherence value at the preset frequency point is less than the preset threshold, it indicates that the first sound signal and the second sound signal are not coherent at the preset frequency point, and the current frequency response value of the feedforward filter at the preset frequency point is collected as the target frequency response value. If the coherence value at the preset frequency point is greater than the preset threshold, the filter parameter of the feedforward filter at the preset frequency point is adjusted, the step of obtaining a first sound signal captured by a feedforward microphone and a second sound signal captured by a feedback microphone is returned, until the target frequency response values at all preset frequency points are collected, and the target frequency response values at all preset frequency points are designated as target frequency response information.

Further, the current frequency response information of the feedforward filter is obtained, and the current noise reduction depth of the hearing aid device is calculated according to the current frequency response information and the original target frequency response information. If the current noise reduction depth does not reach the target noise reduction depth, for each preset frequency point, the optimized target frequency response value at each preset frequency point is calculated according to the original target frequency response value of the feedforward filter and the hearing loss value of the target object at the preset frequency point, the optimized target frequency response at each preset frequency point is designated as the optimized target frequency response information, and the deviation value between the optimized target frequency response value at each preset frequency point and the current frequency response value is calculated. The parameter adjustment amplitude and parameter adjustment direction of the feedforward filter at each preset frequency point are searched according to the deviation value at each preset frequency point, the filter parameter of the feedforward filter at each preset frequency point is updated according to the parameter adjustment amplitude and the parameter adjustment direction, which means, the active noise reduction parameter is updated, the current frequency response information of the feedforward filter is re-obtained according to the updated active noise reduction parameter, and the step of determining the current noise reduction depth of the hearing aid device according to the current frequency response information and the original target frequency response information is returned.

Further, if the current noise reduction depth reaches the target noise reduction depth, it indicates that the active noise reduction effect of the hearing aid device has reached the expected active noise reduction effect. Therefore, the current active noise reduction parameter of the hearing aid device is designated as the filter parameter of the feedforward filter, and active noise reduction is performed in the hearing aid device according to the filter parameter.

In the above examples, on the one hand, in the case of limited noise reduction capability of the hearing aid device, noise within the hearing capability of the target object can be canceled as much as possible, while noise beyond the hearing capability of the target object is not necessarily canceled. The noise within the hearing capability of the target object is specifically canceled, and it is unlikely to produce residue noise when the noise reduction capability of the hearing aid device is limited, which can improve the effect of active noise reduction. On the other hand, the noise beyond the hearing capability of the target object does not need to be canceled, which can avoid wasting the noise reduction capability of the hearing aid device and reduce the waste of resources when the hearing aid device performs active noise reduction.

It is to be understood that, although the steps are displayed sequentially according to the instructions of arrows in the flowcharts of the examples described above, these steps are not necessarily performed sequentially according to the sequence instructed by the arrows. Unless otherwise explicitly specified in the present application, execution of the steps is not strictly limited, and the steps may be performed in other sequences. Moreover, at least some of the steps in the flowchart of each example may include a plurality of steps or a plurality of stages. These steps or stages are not necessarily performed at the same time, but may be performed at different time. Execution of the steps or stages is not necessarily sequentially performed, but may be performed alternately with other steps or at least some of steps or stages of other steps.

Based on the same inventive concept, an example of the present application further provides an active noise reduction apparatus used for implementing the active noise reduction method mentioned above. The implementation scheme provided by the apparatus to solve the problems is similar to that described in the above method. Therefore, the specific definitions in one or more examples of the active noise reduction apparatus provided below can refer to the definitions on the active noise reduction method above, and will not be repeated here.

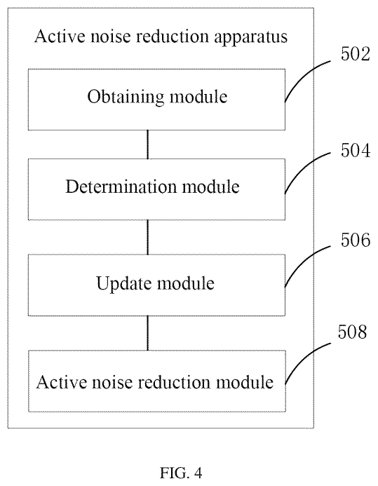

In one example, as shown in FIG. 4, an active noise reduction apparatus is provided, applied to a hearing aid device, including: an obtaining module 502, a determination module 504, an update module 506, and an active noise reduction module 508.

The obtaining module is configured to obtain, in an active noise reduction mode, current frequency response information and original target frequency response information of a feedforward filter.

The determination module is configured to determine a current noise reduction depth of the hearing aid device according to the current frequency response information and the original target frequency response information.

The update module is configured to, if the current noise reduction depth does not reach a target noise reduction depth, update an active noise reduction parameter of the hearing aid device, re-determine the current frequency response information of the feedforward filter according to the updated active noise reduction parameter, and return to the step of determining a current noise reduction depth of the hearing aid device according to the current frequency response information and the original target frequency response information, so that the active noise reduction parameter of the hearing aid device is iteratively adjusted until the current noise reduction depth reaches the target noise reduction depth, and the target noise reduction depth is determined based on hearing loss information of a target object.

The active noise reduction module is configured to, if the current noise reduction depth reaches the target noise reduction depth, perform active noise reduction in the hearing aid device according to the active noise reduction parameter of the hearing aid device.

In one example, the obtaining module is further configured to: obtain a first sound signal captured by a feedforward microphone and a second sound signal captured by a feedback microphone; and determine the original target frequency response information of the feedforward filter according to coherence between the first sound signal and the second sound signal.

In one example, the original target frequency response information includes a target frequency response value at each preset frequency point; the obtaining module is further configured to: calculate a coherence value between the first sound signal and the second sound signal at each preset frequency point; and if the coherence value at the preset frequency point is less than or equal to a preset threshold, collect a current frequency response value of the feedforward filter at the preset frequency point as the target frequency response value; or if the coherence value at the preset frequency point is greater than the preset threshold, return to the step of obtaining a first sound signal captured by a feedforward microphone and a second sound signal captured by a feedback microphone, until target frequency response values at all preset frequency points are collected.

In one example, the update module is further configured to: adjust and optimize the original target frequency response information according to the hearing loss information of the target object, to obtain optimized target frequency response information; determine parameter adjustment information of the feedforward filter according to a deviation between the optimized target frequency response information and the current frequency response information; and update the active noise reduction parameter of the hearing aid device according to the parameter adjustment information.

In one example, the update module is further configured to: obtain current coherence information between the first sound signal captured by the feedforward microphone and the second sound signal captured by the feedback microphone; determine parameter adjustment step information of the feedforward filter according to the current coherence information; and update the active noise reduction parameter of the hearing aid device according to the parameter adjustment step information and the parameter adjustment information.

In one example, the update module is further configured to: obtain the hearing loss information of the target object, and determine target hearing loss information at the feedforward filter according to the hearing loss information and a target transfer function; and optimize and adjust the original target frequency response information of the feedforward filter according to the target hearing loss information, to obtain the optimized target frequency response information,

In one example, the active noise reduction module further includes: a gain adjustment module, configured to detect a residual noise amplitude of the second sound signal captured by the feedback microphone at the preset frequency point; and if the residual noise amplitude at the preset frequency point is greater than a preset amplitude threshold, keep a gain of audio played by the hearing aid device at the preset frequency point unchanged; or if the residual noise amplitude at the preset frequency point is less than or equal to the preset amplitude threshold, decrease the gain of audio played by the hearing aid device at the preset frequency point.

In one example, the active noise reduction module further includes: a noise reduction depth adjustment module, configured to obtain the hearing loss information of the target object; and adjust an original noise reduction depth of the hearing aid device according to the hearing loss information, to obtain the target noise reduction depth of the hearing aid device.

In one example, the noise reduction depth adjustment module is further configured to: receive the hearing loss information sent by a terminal device, where the terminal device is configured to detect the hearing loss information of the target object.

In one example, the noise reduction depth adjustment module is further configured to: receive the hearing loss information sent by a cloud server, where the cloud server is configured to store the hearing loss information of the target object.

The modules in the aforementioned active noise reduction apparatus can be fully or partially implemented by software, hardware, or a combination thereof. The foregoing modules may be embedded in or independent of a processor in the hearing aid device in a form of hardware, or stored in a memory of the hearing aid device in a form of software, whereby the processor calls the modules to perform operations corresponding to the modules.

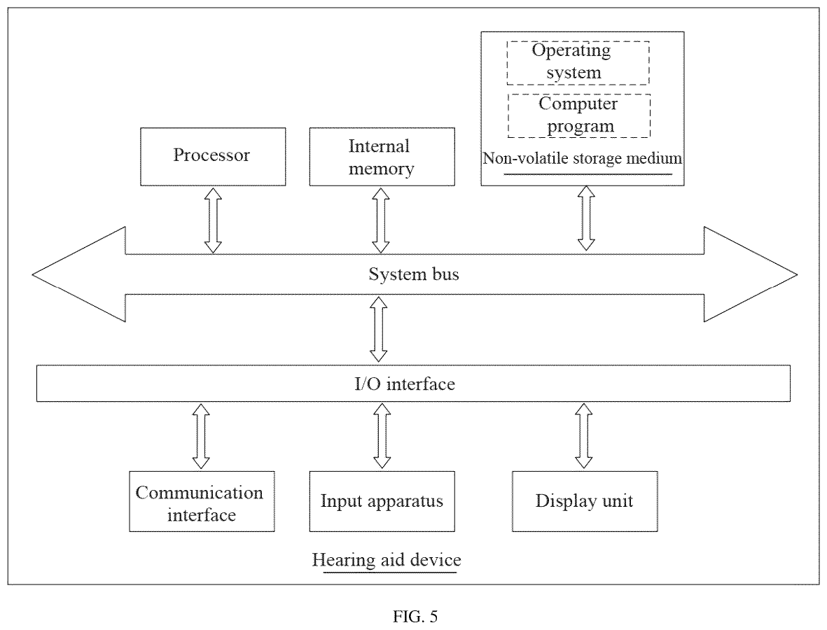

In one example, a hearing aid device is provided, the hearing aid device may be a terminal, and an internal structure of the hearing aid device may be as shown in FIG. 5. The hearing aid device includes a processor, a memory, a communication interface, a display, and an input apparatus connected by a system bus. The processor of the hearing aid device is configured to provide computing and control capabilities. The memory of the hearing aid device includes a non-volatile storage medium and an internal memory. The non-volatile storage medium stores an operating system and a computer program. The internal memory provides an environment for running of the operating system and the computer program in the non-volatile storage medium. The communication interface of the hearing aid device is configured for wired or wireless communication with an external terminal. The wireless communication may be implemented by WIFI, a mobile cellular network, NFC (Near Field Communication), or other technologies. The computer program is executed by the processor to implement the active noise reduction method.

In one example, a hearing aid device is provided, including a memory and a processor, the memory storing a computer program, and the processor implementing the following steps when executing the computer program: obtaining, in an active noise reduction mode, current frequency response information and original target frequency response information of a feedforward filter; determining a current noise reduction depth of the hearing aid device according to the current frequency response information and the original target frequency response information; if the current noise reduction depth does not reach a target noise reduction depth, updating an active noise reduction parameter of the hearing aid device, re-determining the current frequency response information of the feedforward filter according to the updated active noise reduction parameter, and returning to the step of determining a current noise reduction depth of the hearing aid device according to the current frequency response information and the original target frequency response information, where the target noise reduction depth is determined based on hearing loss information of a target object; and if the current noise reduction depth reaches the target noise reduction depth, performing active noise reduction in the hearing aid device according to the active noise reduction parameter of the hearing aid device.

In one example, the processor further implements the following steps when executing the computer program: obtaining a first sound signal captured by a feedforward microphone and a second sound signal captured by a feedback microphone; and determining the original target frequency response information of the feedforward filter according to coherence between the first sound signal and the second sound signal.

In one example, the original target frequency response information includes a target frequency response value at each preset frequency point; the processor further implements the following steps when executing the computer program: calculating a coherence value between the first sound signal and the second sound signal at each preset frequency point; and if the coherence value at the preset frequency point is less than or equal to a preset threshold, collecting a current frequency response value of the feedforward filter at the preset frequency point as the target frequency response value; or if the coherence value at the preset frequency point is greater than the preset threshold, returning to the step of obtaining a first sound signal captured by a feedforward microphone and a second sound signal captured by a feedback microphone, until target frequency response values at all preset frequency points are collected.

In one example, the processor further implements the following steps when executing the computer program: adjusting and optimizing the original target frequency response information according to the hearing loss information of the target object, to obtain optimized target frequency response information; determining parameter adjustment information of the feedforward filter according to a deviation between the optimized target frequency response information and the current frequency response information; and updating the active noise reduction parameter of the hearing aid device according to the parameter adjustment information.

In one example, the processor further implements the following steps when executing the computer program: obtaining current coherence information between the first sound signal captured by the feedforward microphone and the second sound signal captured by the feedback microphone; determining parameter adjustment step information of the feedforward filter according to the current coherence information; and updating the active noise reduction parameter of the hearing aid device according to the parameter adjustment step information and the parameter adjustment information.

In one example, the processor further implements the following steps when executing the computer program: obtaining the hearing loss information of the target object, and determining target hearing loss information at the feedforward filter according to the hearing loss information and a target transfer function; and optimizing and adjusting the original target frequency response information of the feedforward filter according to the target hearing loss information, to obtain the optimized target frequency response information,

In one example, the processor further implements the following steps when executing the computer program: detecting a residual noise amplitude of the second sound signal captured by the feedback microphone at the preset frequency point; and if the residual noise amplitude at the preset frequency point is greater than a preset amplitude threshold, keeping a gain of audio played by the hearing aid device at the preset frequency point unchanged; or if the residual noise amplitude at the preset frequency point is less than or equal to the preset amplitude threshold, decreasing the gain of audio played by the hearing aid device at the preset frequency point.

In one example, the processor further implements the following steps when executing the computer program: obtaining the hearing loss information of the target object; and adjusting an original noise reduction depth of the hearing aid device according to the hearing loss information, to obtain the target noise reduction depth of the hearing aid device.

In one example, the processor further implements the following step when executing the computer program: receiving the hearing loss information sent by a terminal device, where the terminal device is configured to detect the hearing loss information of the target object.

In one example, the processor further implements the following step when executing the computer program: receiving the hearing loss information sent by a cloud server, where the cloud server is configured to store the hearing loss information of the target object.

In one example, a computer-readable storage medium is provided, storing a computer program, where the computer program, when executed by a processor, implements the following steps: obtaining, in an active noise reduction mode, current frequency response information and original target frequency response information of a feedforward filter; determining a current noise reduction depth of the hearing aid device according to the current frequency response information and the original target frequency response information; if the current noise reduction depth does not reach a target noise reduction depth, updating an active noise reduction parameter of the hearing aid device, re-determining the current frequency response information of the feedforward filter according to the updated active noise reduction parameter, and returning to the step of determining a current noise reduction depth of the hearing aid device according to the current frequency response information and the original target frequency response information, where the target noise reduction depth is determined based on hearing loss information of a target object; and if the current noise reduction depth reaches the target noise reduction depth, performing active noise reduction in the hearing aid device according to the active noise reduction parameter of the hearing aid device.

In one example, the computer program, when executed by the processor, further implements the following steps: obtaining a first sound signal captured by a feedforward microphone and a second sound signal captured by a feedback microphone; and determining the original target frequency response information of the feedforward filter according to coherence between the first sound signal and the second sound signal.

In one example, the original target frequency response information includes a target frequency response value at each preset frequency point; the computer program, when executed by the processor, further implements the following steps: calculating a coherence value between the first sound signal and the second sound signal at each preset frequency point; and if the coherence value at the preset frequency point is less than or equal to a preset threshold, collecting a current frequency response value of the feedforward filter at the preset frequency point as the target frequency response value; or if the coherence value at the preset frequency point is greater than the preset threshold, returning to the step of obtaining a first sound signal captured by a feedforward microphone and a second sound signal captured by a feedback microphone, until target frequency response values at all preset frequency points are collected.

In one example, the computer program, when executed by the processor, further implements the following steps: adjusting and optimizing the original target frequency response information according to the hearing loss information of the target object, to obtain optimized target frequency response information; determining parameter adjustment information of the feedforward filter according to a deviation between the optimized target frequency response information and the current frequency response information; and updating the active noise reduction parameter of the hearing aid device according to the parameter adjustment information.

In one example, the computer program, when executed by the processor, further implements the following steps: obtaining current coherence information between the first sound signal captured by the feedforward microphone and the second sound signal captured by the feedback microphone; determining parameter adjustment step information of the feedforward filter according to the current coherence information; and updating the active noise reduction parameter of the hearing aid device according to the parameter adjustment step information and the parameter adjustment information.

In one example, the computer program, when executed by the processor, further implements the following steps: obtaining the hearing loss information of the target object, and determining target hearing loss information at the feedforward filter according to the hearing loss information and a target transfer function; and optimizing and adjusting the original target frequency response information of the feedforward filter according to the target hearing loss information, to obtain the optimized target frequency response information,

In one example, the computer program, when executed by the processor, further implements the following steps: detecting a residual noise amplitude of the second sound signal captured by the feedback microphone at the preset frequency point; and if the residual noise amplitude at the preset frequency point is greater than a preset amplitude threshold, keeping a gain of audio played by the hearing aid device at the preset frequency point unchanged; or if the residual noise amplitude at the preset frequency point is less than or equal to the preset amplitude threshold, decreasing the gain of audio played by the hearing aid device at the preset frequency point.

In one example, the computer program, when executed by the processor, further implements the following steps: obtaining the hearing loss information of the target object; and adjusting an original noise reduction depth of the hearing aid device according to the hearing loss information, to obtain the target noise reduction depth of the hearing aid device.

In one example, the computer program, when executed by the processor, further implements the following step: receiving the hearing loss information sent by a terminal device, where the terminal device is configured to detect the hearing loss information of the target object.

In one example, the computer program, when executed by the processor, further implements the following step: receiving the hearing loss information sent by a cloud server, where the cloud server is configured to store the hearing loss information of the target object.

In one example, a computer program product is provided, including a computer program that, when executed by a processor, implements the following steps: obtaining, in an active noise reduction mode, current frequency response information and original target frequency response information of a feedforward filter; determining a current noise reduction depth of the hearing aid device according to the current frequency response information and the original target frequency response information; if the current noise reduction depth does not reach a target noise reduction depth, updating an active noise reduction parameter of the hearing aid device, re-determining the current frequency response information of the feedforward filter according to the updated active noise reduction parameter, and returning to the step of determining a current noise reduction depth of the hearing aid device according to the current frequency response information and the original target frequency response information, where the target noise reduction depth is determined based on hearing loss information of a target object; and if the current noise reduction depth reaches the target noise reduction depth, performing active noise reduction in the hearing aid device according to the active noise reduction parameter of the hearing aid device.

In one example, the computer program, when executed by the processor, further implements the following steps: obtaining a first sound signal captured by a feedforward microphone and a second sound signal captured by a feedback microphone; and determining the original target frequency response information of the feedforward filter according to coherence between the first sound signal and the second sound signal.

In one example, the original target frequency response information includes a target frequency response value at each preset frequency point; the computer program, when executed by the processor, further implements the following steps: calculating a coherence value between the first sound signal and the second sound signal at each preset frequency point; and if the coherence value at the preset frequency point is less than or equal to a preset threshold, collecting a current frequency response value of the feedforward filter at the preset frequency point as the target frequency response value; or if the coherence value at the preset frequency point is greater than the preset threshold, returning to the step of obtaining a first sound signal captured by a feedforward microphone and a second sound signal captured by a feedback microphone, until target frequency response values at all preset frequency points are collected.

In one example, the computer program, when executed by the processor, further implements the following steps: adjusting and optimizing the original target frequency response information according to the hearing loss information of the target object, to obtain optimized target frequency response information; determining parameter adjustment information of the feedforward filter according to a deviation between the optimized target frequency response information and the current frequency response information; and updating the active noise reduction parameter of the hearing aid device according to the parameter adjustment information.

In one example, the computer program, when executed by the processor, further implements the following steps: obtaining current coherence information between the first sound signal captured by the feedforward microphone and the second sound signal captured by the feedback microphone; determining parameter adjustment step information of the feedforward filter according to the current coherence information; and updating the active noise reduction parameter of the hearing aid device according to the parameter adjustment step information and the parameter adjustment information.

In one example, the computer program, when executed by the processor, further implements the following steps: obtaining the hearing loss information of the target object, and determining target hearing loss information at the feedforward filter according to the hearing loss information and a target transfer function; and optimizing and adjusting the original target frequency response information of the feedforward filter according to the target hearing loss information, to obtain the optimized target frequency response information,

In one example, the computer program, when executed by the processor, further implements the following steps: detecting a residual noise amplitude of the second sound signal captured by the feedback microphone at the preset frequency point; and if the residual noise amplitude at the preset frequency point is greater than a preset amplitude threshold, keeping a gain of audio played by the hearing aid device at the preset frequency point unchanged; or if the residual noise amplitude at the preset frequency point is less than or equal to the preset amplitude threshold, decreasing the gain of audio played by the hearing aid device at the preset frequency point.

In one example, the computer program, when executed by the processor, further implements the following steps: obtaining the hearing loss information of the target object; and adjusting an original noise reduction depth of the hearing aid device according to the hearing loss information, to obtain the target noise reduction depth of the hearing aid device.

In one example, the computer program, when executed by the processor, further implements the following step: receiving the hearing loss information sent by a terminal device, where the terminal device is configured to detect the hearing loss information of the target object.

In one example, the computer program, when executed by the processor, further implements the following step: receiving the hearing loss information sent by a cloud server, where the cloud server is configured to store the hearing loss information of the target object.

A person of ordinary skill in the art can understand that all or part of the processes in the methods of the foregoing examples can be implemented by a computer program instructing relevant hardware. The computer program may be stored in a non-volatile computer-readable storage medium. The computer program, when executed, may include the processes of the examples of the above methods. Any reference to the memory, the database, or other medium used in the examples provided in this application may all include a non-volatile or volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may be a random access memory (RAM), an external cache, or the like. As an illustration and not a limitation, the RAM can be in many forms, such as a static random access memory (SRAM) or a dynamic random access memory (DRAM). The database involved in each example provided in this application may include at least one of a relational database and a non-relational database. The non-relational database may include, but is not limited to, a blockchain-based distributed database and the like. The processor involved in each example provided in this application may be a general-purpose processor, a central processing unit, a graphics processing unit, a digital signal processor, a programmable logic device, a data processing logic device based on quantum computing, and the like, but is not limited to this.

Technical features of the foregoing examples may be randomly combined. To make description concise, not all possible combinations of the technical features in the foregoing examples are described. However, the combinations of these technical features are considered as falling within the scope recorded by this specification provided that no conflict exists.

The foregoing examples show only several implementations of this application and are described in detail, which, however, are not to be construed as a limitation to the patent scope of this application. It should be noted that those of ordinary skill in the art can make some variations and improvements without departing from the concept of the present application, and these variations and improvements all fall into the protection scope of the present application. Therefore, the scope of protection of the present application should be subject to the appended claims.

What is claimed is:

1. An active noise reduction method comprising:
obtaining, in an active noise reduction mode of a hearing aid device, current frequency response information and original target frequency response information of a feedforward filter;
determining, based on the current frequency response information and the original target frequency response information, a current noise reduction depth of the hearing aid device;
based on determining that the current noise reduction depth does not reach a target noise reduction depth, iteratively adjusting an active noise reduction parameter of the hearing aid device until the current noise reduction depth reaches the target noise reduction depth, by:
updating the active noise reduction parameter of the hearing aid device;
re-determining, based on the updated active noise reduction parameter, the current frequency response information of the feedforward filter; and
updating, based on the re-determined current frequency response information and the original target frequency response information, the current noise reduction depth of the hearing aid device, wherein the target noise reduction depth is determined based on hearing loss information of a target object; and
based on determining that the current noise reduction depth reaches the target noise reduction depth, performing active noise reduction in the hearing aid device according to the active noise reduction parameter of the hearing aid device.

2. The method according to claim 1, wherein the obtaining the original target frequency response information comprises:
obtaining a first sound signal captured by a feedforward microphone of the hearing aid device and a second sound signal captured by a feedback microphone of the hearing aid device; and
determining, based on coherence between the first sound signal and the second sound signal, the original target frequency response information of the feedforward filter.

3. The method according to claim 2, wherein the original target frequency response information comprises a target frequency response value at each preset frequency point, and wherein the determining the original target frequency response information comprises:
for each preset frequency point on a list of preset frequency points:
calculating a coherence value between the first sound signal and the second sound signal at the preset frequency point; and
based on determining that the coherence value at the preset frequency point is less than or equal to a preset threshold, collecting a current frequency response value of the feedforward filter at the preset frequency point as the target frequency response value; or
based on determining that the coherence value at each preset frequency point is greater than the preset threshold, returning to the step of obtaining the first sound signal captured by the feedforward microphone and the second sound signal captured by the feedback microphone, until target frequency response values at all preset frequency points on the list are collected.

4. The method according to claim 2, wherein the updating the active noise reduction parameter of the hearing aid device comprises:
adjusting, based on the hearing loss information of the target object, the original target frequency response information to obtain optimized target frequency response information;
determining, based on a deviation between the optimized target frequency response information and the current frequency response information, parameter adjustment information of the feedforward filter; and
updating, based on the parameter adjustment information, the active noise reduction parameter of the hearing aid device.

5. The method according to claim 4, wherein the updating the active noise reduction parameter of the hearing aid device comprises:
obtaining current coherence information between the first sound signal captured by the feedforward microphone and the second sound signal captured by the feedback microphone,
wherein determining the parameter adjustment information of the feedforward filter is further based on the current coherence information.

6. The method according to claim 4, wherein the adjusting the original target frequency response information comprises:
obtaining the hearing loss information of the target object; and
determining, based on the hearing loss information and a target transfer function, target hearing loss information at the feedforward filter,
wherein the adjusting the original target frequency response information to obtain the optimized target frequency response information is further based on the target hearing loss information.

7. The method according to claim 3, further comprising:
detecting a residual noise amplitude of the second sound signal captured by the feedback microphone at a particular preset frequency point; and
based on determining that the residual noise amplitude at the particular preset frequency point is greater than a preset amplitude threshold, maintaining a gain of audio played by the hearing aid device at the particular preset frequency point unchanged; or
based on determining that the residual noise amplitude at the particular preset frequency point is less than or equal to the preset amplitude threshold, decreasing the gain of audio played by the hearing aid device at the particular preset frequency point.

8. The method according to claim 1, further comprising:
prior to obtaining the current frequency response information and the original target frequency response information of the feedforward filter, obtaining the hearing loss information of the target object; and
adjusting, based on the hearing loss information, an original noise reduction depth of the hearing aid device to obtain the target noise reduction depth of the hearing aid device.

9. The method according to claim 8, wherein the obtaining the hearing loss information of the target object comprises at least one of the following:
receiving the hearing loss information sent by a terminal device, wherein the terminal device is configured to detect the hearing loss information of the target object; and
receiving the hearing loss information sent by a cloud server, wherein the cloud server is configured to store the hearing loss information of the target object.

10. A hearing aid device, comprising:
a processor, and
a memory in communication with the processor and storing instructions that, when read by the processor, cause the hearing aid device to:
obtain, in an active noise reduction mode, current frequency response information and original target frequency response information of a feedforward filter;
determine, based on the current frequency response information and the original target frequency response information, a current noise reduction depth of the hearing aid device;
based on determining that the current noise reduction depth does not reach a target noise reduction depth, iteratively adjust an active noise reduction parameter of the hearing aid device until the current noise reduction depth reaches the target noise reduction depth, by:
updating the active noise reduction parameter of the hearing aid device;
re-determining, based on the updated active noise reduction parameter, the current frequency response information of the feedforward filter; and
updating, based on the re-determined current frequency response information and the original target frequency response information, the current noise reduction depth of the hearing aid device, wherein the target noise reduction depth is determined based on hearing loss information of a target object; and
based on determining that the current noise reduction depth reaches the target noise reduction depth, perform active noise reduction in the hearing aid device according to the active noise reduction parameter of the hearing aid device.

11. The hearing aid device according to claim 10, wherein the instructions, when executed by the processor, further cause the hearing device to obtain the original target frequency response information by:
obtaining a first sound signal captured by a feedforward microphone of the hearing aid device and a second sound signal captured by a feedback microphone of the hearing aid device; and
determining, based on coherence between the first sound signal and the second sound signal, the original target frequency response information of the feedforward filter.

12. The hearing aid device according to claim 11, wherein the original target frequency response information comprises a target frequency response value at each preset frequency point, and wherein the instructions, when executed by the processor, further cause the hearing aid device to determine the original target frequency response information by:
for each preset frequency point on a list of preset frequency points:
calculating a coherence value between the first sound signal and the second sound signal at the preset frequency point; and
based on determining that the coherence value at the preset frequency point is less than or equal to a preset threshold, collecting a current frequency response value of the feedforward filter at the preset frequency point as the target frequency response value; or
based on determining that the coherence value at each preset frequency point is greater than the preset threshold, returning to the step of obtaining the first sound signal captured by the feedforward microphone and the second sound signal captured by the feedback microphone, until target frequency response values at all preset frequency points on the list are collected.

13. The hearing aid device according to claim 11, wherein the instructions, when executed by the processor, further cause the hearing aid device to update the active noise reduction parameter of the hearing aid device by:
adjusting, based on the hearing loss information of the target object, the original target frequency response information to obtain optimized target frequency response information;
determining, based on a deviation between the optimized target frequency response information and the current frequency response information, parameter adjustment information of the feedforward filter; and
updating, based on the parameter adjustment information, the active noise reduction parameter of the hearing aid device.

14. The hearing aid device according to claim 13, wherein the instructions, when executed by the processor, further cause the hearing aid device to update the active noise reduction parameter of the hearing aid device by:
obtaining current coherence information between the first sound signal captured by the feedforward microphone and the second sound signal captured by the feedback microphone,
wherein determining the parameter adjustment information of the feedforward filter is further based on the current coherence information.

15. The hearing aid device according to claim 13, wherein the instructions, when executed by the processor, further cause the hearing aid device to adjust the original target frequency response information by:
obtaining the hearing loss information of the target object; and
determining, based on the hearing loss information and a target transfer function, target hearing loss information at the feedforward filter,
wherein the adjusting the original target frequency response information to obtain the optimized target frequency response information is further based on the target hearing loss information.

16. The hearing aid device according to claim 12, wherein the instructions, when executed by the processor, further cause the device to:
detect a residual noise amplitude of the second sound signal captured by the feedback microphone at a particular preset frequency point; and
after determining that the residual noise amplitude at the particular preset frequency point is greater than a preset amplitude threshold, maintain a gain of audio played by the hearing aid device at the particular preset frequency point unchanged; or
after determining that the residual noise amplitude at the particular preset frequency point is less than or equal to the preset amplitude threshold, decrease the gain of audio played by the hearing aid device at the particular preset frequency point.

17. The hearing aid device according to claim 10, wherein the instructions, when executed by the processor, further cause the device to:
prior to obtaining the current frequency response information and the original target frequency response information of the feedforward filter, obtain the hearing loss information of the target object; and
adjust, based on the hearing loss information, an original noise reduction depth of the hearing aid device to obtain the target noise reduction depth of the hearing aid device.

18. The hearing aid device according to claim 17, wherein the instructions, when executed by the processor, further cause the hearing aid device to obtain the hearing loss information of the target object by at least one of the following:
receiving the hearing loss information sent by a terminal device, wherein the terminal device is configured to detect the hearing loss information of the target object; and
receiving the hearing loss information sent by a cloud server, wherein the cloud server is configured to store the hearing loss information of the target object.

19. A non-transitory computer-readable medium storing instructions that, when executed by one or more processors, cause the one or more processors to perform steps comprising:
obtaining, in an active noise reduction mode, current frequency response information and original target frequency response information of a feedforward filter of a hearing aid device;
determining, based on the current frequency response information and the original target frequency response information, a current noise reduction depth of the hearing aid device;
after determining that the current noise reduction depth does not reach a target noise reduction depth, iteratively adjusting an active noise reduction parameter of the hearing aid device until the current noise reduction depth reaches the target noise reduction depth, by:
updating the active noise reduction parameter of the hearing aid device;
re-determining, based on the updated active noise reduction parameter, the current frequency response information of the feedforward filter; and
updating, based on the re-determined current frequency response information and the original target frequency response information, the current noise reduction depth of the hearing aid device, wherein the target noise reduction depth is determined based on hearing loss information of a target object; and
after determining that the current noise reduction depth reaches the target noise reduction depth, performing active noise reduction in the hearing aid device according to the active noise reduction parameter of the hearing aid device.

20. The non-transitory computer-readable medium of claim 19, wherein the instructions, when executed by the one or more processors, cause the one or more processors to perform steps comprising:
obtaining a first sound signal captured by a feedforward microphone and a second sound signal captured by a feedback microphone; and
determining, based on coherence between the first sound signal and the second sound signal, the original target frequency response information of the feedforward filter.
